(19) United States
(12) Patent Application Publication
(10) Pub. No.: US 2009/0006469 A1
(43) Pub. Date: Jan. 1, 2009

(54) CLUSTERING USERS USING CONTEXTUAL OBJECT INTERACTIONS

(75) Inventors: Kamal Jain, Bellevue, WA (US); James Russell, Seattle, WA (US); Arun K. Sacheti, Sammamish, WA (US); Bradley W. Ward, Seattle, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/768,536

(22) Filed: Jun. 26, 2007

(51) Int. Cl. G06F 17/30

(52) U.S. Cl. 707/104.1; 707/E17.046

(57) ABSTRACT

Systems and/or methods are presented that facilitate creating clusters of users that can be linked to each other based on common interactions of such users with an object associated with an advertisement for a product or service. A central service component can track activity and receive data associated with objects, including data related to interactions with such objects by users in a community network. An evaluation component can analyze received data, and can create links between users and/or clusters of users based on common interactions of users with a particular object. The evaluation component can also link clusters that have a particular user in common. The evaluation component can assign a rank or weight level to descriptive content associated with an object, and an associated product or service, based on common object interactions between users.

### BACKGROUND

Computing and network technologies have transformed many aspects of everyday life. Networking technologies like the Internet provide individuals virtually unlimited access to remote systems, information and associated applications. As computing and network technologies have evolved and have become more robust, secure and reliable, more consumers, wholesalers, retailers, service providers, entrepreneurs, educational institutions and the like are shifting paradigms and are employing the Internet to perform business in addition to traditional means. For example, merchants and service providers can use online advertisements to sell or promote their products or services either through their own web sites, e-mail or other electronic message advertising, and/or advertisements that can appear on web sites or blogs of third parties.

To better target advertisements to individuals who may have an interest in the product or service marketed by a particular advertisement, advertisers strive to gain information about such individuals, such as their respective interests, activities, habits, purchases, etc. Further, advertisers desire to gain information regarding common interests and relationships between individuals, as such information can also facilitate targeting of advertisements by advertisers.

For example, if person A and person B are known to have a relationship with each other, they may have similar interests. Further, persons who are known by an advertiser to have at least one interest in common may also have other interests in common. An advertiser can utilize information regarding such common relationships and/or interests to facilitate targeting advertising.

Conventionally, discovering relationships between users has typically been achieved by examining explicit user interactions. For example, by traversing a contact list of a user, a related cluster of users can be established. However, this approach involves a user taking an explicit action to add another user to his/her contact list. The user cluster constructed from this information can be valuable, particularly for the targeting of advertisements. Thus, while these clusters can present an advertiser with useful information regarding users, clustering users based on a user contact list is only realized as a result of a user taking a proactive effort to establish relationships with other users and requiring a direct channel of communication between the users. This can limit the scope of the cluster greatly, as many users tend not to maintain huge contact lists or communicate directly with a large number of users.

It is desirable to be able to gain information regarding users, so that advertisers can target advertising to users and/or other entities can target providing information to users. Further, it is desirable to be able to cluster or link users who may have common interests or relationships without having to rely on users taking explicit actions to form online relationships.

### SUMMARY

The following presents a simplified summary in order to provide a basic understanding of some aspects of the disclosed subject matter. This summary is not an extensive overview of the disclosed subject matter and is not intended to identify key/critical elements or to delineate the scope of such subject matter. Its sole purpose is to present some concepts in a simplified form as a prelude to the more detailed description that is presented later.

Systems and/or methods that can facilitate clusterization of users with regard to common interactions are presented. In accordance with one aspect of the disclosed subject matter, a central service component (also referred to herein as “CSC”) can track interaction of users with regard to one or more objects that can be displayed and/or embedded in a web site(s), web page(s), and/or blog(s), and/or other electronic communication, and can facilitate clustering users based in part upon user interaction with the object(s) and/or information (e.g., contextual information) associated with the object(s).

In accordance with an aspect of the disclosed subject matter, users can be registered with a common identity service that can facilitate identifying and authenticating respective users who are associated with a community network. While a user is logged in via the common identity service and is traversing the community network, the CSC can monitor and receive data associated with interactions of users with regard to objects displayed or embedded in web sites, blogs, e-mails, and the like. The CSC can include an evaluation component that can monitor, collect, and analyze received data and can determine contextual link(s) between particular users based in part on common interactions of users with regard to the respective objects (e.g., controls) that can be included in or associated with, for example, centrally hosted services (e.g., weather information service, online status information service, etc.), and/or advertisements and/or other items, which can be associated with products and/or services, and can be displayed in web sites, blogs, e-mails, and the like. The CSC can generate clusters of users based in part upon user interaction with the object(s) and/or information (e.g., centrally hosted service(s), advertisement(s), other item(s)) associated with the object(s)).

In accordance with another aspect of the disclosed subject matter, the evaluation component can link clusters together when such clusters have a particular user in common. Further, the evaluation component can associate contextual information associated with each cluster to such other cluster(s) to which it is linked.

In accordance with yet another aspect of the disclosed subject matter, the CSC can employ the clusters, and utilize information related thereto, to facilitate determining and/or generating a rating regarding comments, reviews, and ratings given by users with regard to products and/or services. In determining or generating such a rating, the evaluation component can assign a weight level to the community ratings and/or reviews of a product based in part on the relationship between the user that authored the rating or review and the user that is reading the rating or review. For example, the review of a product by an author can be assigned a higher weight level when presented to the reader of the review, where the author and reader are in one or more clusters together, as opposed to weight level assigned to a review of the product by an author with whom the reader does not share a cluster.

To the accomplishment of the foregoing and related ends, certain illustrative aspects are described herein in connection with the following description and the annexed drawings. These aspects are indicative of various ways in which the disclosed subject matter may be practiced, all of which are intended to be within the scope of the disclosed subject matter. Other advantages and novel features may become apparent from the following detailed description when considered in conjunction with the drawings.

### BRIEF DESCRIPTION OF THE DRAWINGS

FIG. 1 illustrates a block diagram of a system that facilitates creation of clusters of users based upon common object interactions of users in accordance with the disclosed subject matter.

FIG. 2 illustrates a block diagram of a system that facilitates creation of clusters of users in accordance with the disclosed subject matter.

FIG. 3 illustrates a block diagram of yet another system that facilitates creation of clusters of users in accordance with the disclosed subject matter.

FIG. 4 illustrates a block diagram of a system that facilitates communication with a community network to facilitate creation of clusters of users in accordance with the disclosed subject matter.

FIG. 5 illustrates a block diagram of a system that employs intelligence to facilitate creation of clusters of users in accordance with the disclosed subject matter.

FIG. 6 depicts a block diagram of a system that employs a centrally hosted service(s) to facilitate the contextual cluster of users in accordance with the disclosed subject matter.

FIG. 7 is a representative flow diagram illustrating a methodology that facilitates creating clusters of user based on common object interactions of users in accordance with an aspect of the disclosed subject matter.

FIG. 8 is a representative flow diagram depicting another methodology that facilitates creating clusters of user based on common object interactions of users in accordance with the disclosed subject matter.

FIG. 9 is a representative flow diagram illustrating a methodology that facilitates linking clusters based in part on a common user(s) in accordance with the disclosed subject matter.

FIG. 10 is a representative flow diagram illustrating a methodology that facilitates assigning a rank and/or a weight level to contextual content based in part on common object interactions of users in accordance with the disclosed subject matter.

FIG. 11 is a schematic block diagram illustrating a suitable operating environment.

FIG. 12 is a schematic block diagram of a sample-computing environment.

### DETAILED DESCRIPTION

The various aspects of the disclosed subject matter are now described with reference to the annexed drawings, wherein like numerals refer to like or corresponding elements throughout. It should be understood, however, that the drawings and detailed description relating thereto are not intended to limit the disclosed subject matter to the particular form disclosed. Rather, the intention is to cover all modifications, equivalents, and alternatives falling within the spirit and scope of the disclosed subject matter.

As used in this application, the terms “component,” “system,” “store,” “interface,” and the like are intended to refer to a computer-related entity, either hardware, a combination of hardware and software, software, software in execution, and/or firmware. For example, a component may be, but is not limited to being, a process running on a processor, a processor, an object, an instance, an executable, a thread of execution, a program and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over the other aspects or designs.

Furthermore, all or portions of the subject innovation may be implemented as a method, apparatus, or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device, carrier, or media. For example, computer readable media can include but is not limited to magnetic storage devices (e.g., hard disk, floppy disk, magnetic strips . . . ), optical disks (e.g., compact disk (CD), digital versatile disk (DVD . . . )), smart cards, and flash memory devices (e.g. card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the disclosed subject matter.

Advertisers (e.g., including merchants, wholesalers, retailers, etc.) desire to gain information regarding people, and particularly the relationships and common interests between persons in order to better target their advertising to those persons who may have an interest in the product or service advertised based on common relationships and/or common interests of persons. Advertisers utilize such information both in the offline and online communities. Conventionally, in an online community network, an advertiser can discover relationships between users by examining explicit user interactions, such as by traversing a contact list of a user, a related cluster of users can be established. However, such approach can be of limited value because information regarding such relationships between users can only be obtained if the user takes affirmative action to establish the relationship or connection with another user. It is desirable to be able to gain information regarding relationships between users in the online community, and to be able to cluster or link users who may have common interests or relationships without having to rely on users taking explicit actions to form such online relationships.

Systems and/or methods are presented that facilitate clustering users based on common interactions with an object(s) by respective users. A central service component can be employed and can receive information associated with objects that can each be respectively associated with a centrally hosted service (e.g., weather information service, stock quote service, etc.) and/or an advertisement for a product(s) or service(s). Such advertisements can be included on a web site, a web page, a blog, an e-mail, an instant message, etc. The central service component can include an evaluation component that can analyze and evaluate such data to facilitate determining links between users that have had common interactions with an object(s).

The evaluation component can create a cluster of users where each user in the cluster has interacted with such object, and the cluster can be associated with the object and contextual information associated therewith. Further, the evaluation component can link clusters to each other where such clusters have at least one user in common. The evaluation component can also facilitate ranking and/or assigning a weight level to content (e.g., reviews, comments, ratings, etc.) associated with the object, and associated product/service, that can be published by other users, where such ranking and/or weight level can be based in part on the number and/or the type of contextual links respectively between the user being presented with such content and the other users publishing such content.

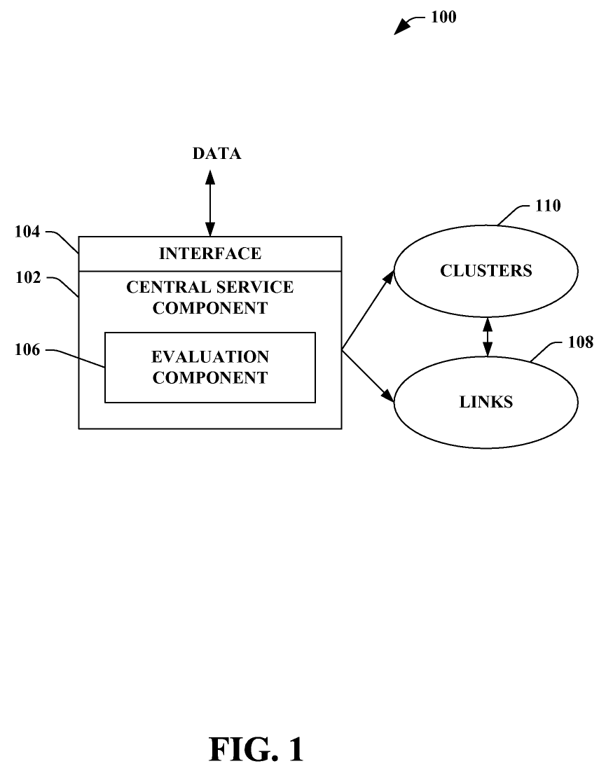

Turning now to FIG. 1, an illustration of a system 100 that facilitates determining common interactions of users and clustering users based on common interactions is depicted. In accordance with one aspect of the disclosed subject matter, a system 100 can include a central service component 102 (hereinafter also referred to as “CSC 102”) that can receive data via an interface component 104 (e.g., discussed infra) to facilitate determining common interactions between users, clustering users based in part on common interactions, and/or linking objects and users based on interactions with such objects by a user.

CSC 102 can receive data, via interface component 104, including data associated with users in a community network; objects (e.g., controls) and/or advertisements associated therewith; contextual information respectively associated with objects and/or advertisements, etc. The contextual information can include information relating to a product(s) and/or a service(s) marketed by an advertisement; information (e.g., content) associated with the host container (e.g., web site, blog, e-mail, etc.) where the object is posted, embedded, and/or displayed; metadata (e.g., product or service description, as well as comments, reviews, and/or ratings regarding a product or service); etc. The metadata associated with the object (e.g., product description) as well as the contents of the host container (e.g., website) can be used to define the context in which the control was encountered and hence provide valuable contextual information on the users who encountered the control

An object can be a control or other mechanism that can be manipulated by a user, and can be associated with and/or included in an advertisement(s) that can market a product(s) and/or a service(s), and/or a centrally hosted service that can be hosted by an entity (e.g., advertiser, merchant, etc.) that desires information regarding users. Further, the object and/or advertisement can request, suggest, and/or desire that a desired action be performed by a person (e.g., user) with regard to the product(s) and/or service(s) marketed by the advertisement. The advertisement can include, for example, promotional content, an offer, and/or a request to contact a friend (e.g., “refer a friend”, “e-mail a friend”), related to a product, a service, and/or other commerce; and/or can be and/or can include therein any content that requests, suggests, and/or desires that another person or entity take desired action with regard to the product and/or service marketed by the advertisement.

The object can also be associated with a centrally hosted service, such as weather information, instant message or online status information regarding users, stock quotes, horoscope information, news feed, sports feed, a counter related to users who access the host site, and/or graphics, for example. The centrally hosted service can be provided by the entity via the CSC 102 and/or another component (not shown), and the object and associated service can be included in the host container (e.g., web site, blog) of a user-publisher. The user-publisher can benefit by having additional functionality and/or services on his/her site and/or by an incentive provided to the user-publisher by the hosting entity. Further, the CSC 102, and thereby the hosting entity, can obtain information regarding users who access the site of the publisher-user.

In accordance with one embodiment of the disclosed subject matter, when a user requests the page (e.g., site) of the user-publisher, the request can be provided to the CSC 102, and the CSC 102 can receive and/or capture information, including identification information, regarding the user who is requesting access to the site, as well as other information, such as contextual information associated with the host container (e.g., site of the user-publisher). The CSC 102 can also facilitate connection of the user to the requested site. Thus, by a user simply accessing a site of the user-publisher, the CSC 102 can obtain information regarding the user.

In accordance with another embodiment of the disclosed subject matter, the central hosted service can be provided via a central host service component (not shown), which can receive the request from the user, can receive and/or capture the information regarding the user and/or the host container, and can facilitate connecting the user to the requested page. The central host service component can also facilitate providing the received/captured information to the CSC 102.

An object (e.g., control), and/or an advertisement associated therewith, can be included in a host container, such as a web site, a web page, a blog, an online subscription service, a webfeed, an e-mail, an instant message, short message service (SMS), enhanced messaging service (EMS), multimedia messaging service (MMS), and/or other electronic communication that can be made from a user to another person (e.g., another user) or entity. Further, the object can be associated with and/or included in an advertisement and/or other information associated with a product and/or service. An interaction between a user and an object can include manipulating the object via, for example, a click of a mouse, a key stroke, a voice command, etc. and/or taking other action with regard to the object.

Promotional content can include, for example, product screenshots, box shots, videos, descriptive information, and/or hyperlinks to another online location (e.g., web site, web page) where the aforementioned promotional content can be perceived. Further, promotional content can be a viral agent, such as a promotional trailer for a product and/or service.

A desired action can include, for example, with regard to the product or service marketed by the advertisement, making a purchase of the product or service, sampling the product or service (e.g., test drive a car, free trial of a product or service), downloading software associated with the product or service, registering for the product or service (whether free or as a purchase), filling out a form or survey associated with the product or service, making an appointment associated with the product or service, providing a review or comments regarding the product or service, syndicating the advertising package marketing the product or service that was referred to the recipient, etc.

CSC 102 can include an evaluation component 106 that can analyze and evaluate data received by the CSC 102, and can make determinations regarding whether an interaction has occurred between a user and an object. The evaluation component 106 can facilitate creating a link 108 between the user and the object when there is an interaction between the user and the object, such as when the user manipulates the object. The evaluation component 106 can utilize links 108 between a user(s) and an object(s) to facilitate creating clusters 110 of users based in part on common object interactions. Further, the evaluation component 106 can create a link 108 and/or association between the user and the contextual information (e.g., advertisement information, information contained in the host container, etc.) associated with the object with which the user interacted. Such contextual information can be utilized to define the context in which the object was encountered by the user, which can thereby provide valuable contextual information regarding the user who encountered the object.

For example, a user can view an advertisement with an object associated therewith displayed on a web site. If the user is interested in product or service marketed by the advertisement, the user can be identified and authenticated against a common identity service (not shown) that can be associated with the object, so that the user can be identified by the common identity service and/or the CSC 102. The user can interact with (e.g., manipulate) the object and can then perform a desired action (e.g., purchase) with related to the product or service marketed by the advertisement. Data regarding the interaction with the object by the user can be received by the CSC 102 and can be stored in a data store (not shown) that can be associated therewith. As a result of the object interaction, the user can then be linked 108 (e.g., associated) with the object and contextual information associated therewith.

It is to be appreciated that the user can begin the interaction with the object prior to authenticating with the common identity service. If the user manipulates the object prior to authenticating with the common identity service, the CSC 102 can facilitate making a request to the user to provide authentication information to authenticate the user before the object interaction continues, and once the user is authenticated, the user can continue with the object interaction, and data regarding such interaction can be received by the CSC 102.

In accordance with another aspect of the disclosed subject matter, the evaluation component 106 can make determinations regarding whether particular users have one or more interactions in common, that is, whether particular users each have interacted with the same object(s). The evaluation component 106 can facilitate creating a link 108 between users that have interacted with the same object(s). The evaluation component 106 can utilize link(s) 108 between users to facilitate creating one or more clusters 110 of users, where each cluster 110 can include users who each have had at least one interaction with the same object.

For example, an object can be included in an advertisement for a product, which can be placed on a web site. A first user visits the web site and views the advertisement. The first user decides to purchase the product. To purchase the product, the first user can authenticate against a common identity service that can identify and verify a user, and the first user can purchase the product by manipulating (e.g., clicking on the object with a mouse) the object. Information regarding the interaction between the first user and the object can be received by the CSC 102 and can be stored in a data store that can be associated therewith. Another user can then view the same advertisement on the same web site, and can decide to purchase the product. The other user can authenticate against the common identity service to identify the other user, and the other user can purchase the product by manipulating the object associated with the advertisement. Information regarding the interaction between the other user and the object can be received by the CSC 102 and can be stored in the data store.

Evaluation component 106 can analyze the information regarding the object, the first user, and the other user, and can determine that the first user and the other user have both interacted with the same object. Based on this common interaction, evaluation component 106 can create a link 108 between the first user and other user. Further, evaluation component 106 can generate a cluster 110 that can include the first user and the other user, since these users can be linked to each other. The cluster 110 can be associated with the contextual information associated with the object, where such contextual information can include information related to the advertisement, the product or service marketed by the advertisement, the host container wherein the object or advertisement was displayed, etc. As a result, the first user and other user now can be contextually related by their common interaction with this object.

Further, in accordance with still another aspect of the disclosed subject matter, links 108 can be predefined between objects respectively associated with the same or similar advertisements that can appear in different locations (e.g., web sites, blogs), as desired, for example, by an advertiser. As an example, a first user can interact with an object in a first advertisement displayed in a first web site, and information regarding the object interaction can be received by the CSC 102. The first advertisement can be predefined as linked to a second advertisement that is similar to the first advertisement (e.g., the advertisements market the same product) and is displayed on a second web site, and CSC 102 can receive information regarding such predefined link and can create a link 108 between the advertisements. A second user can interact with an object associated with the second advertisement, and the CSC 102 can receive information regarding such interaction. The evaluation component 106 can create a contextual link 108 between the first user and the second user, since the users interacted with objects that were linked. The first user and the second user can then be grouped together in a cluster 110 associated with the object and contextual information associated therewith.

In accordance with yet another aspect of the disclosed subject matter, the evaluation component 106 can also make determinations whether more than one object has had interactions with a particular user. The evaluation component 106 can facilitate creating a link 108 between objects when each of the objects has had one or more interactions with a particular user. The evaluation component 106 can utilize the link(s) 108 between objects that have at least one interaction in common with a particular user to facilitate creating a link(s) 108 between the cluster 110 (e.g., group) of users that have interacted with one such object linked to the particular user and the cluster 108 of users that have interacted with another such object(s) linked to the particular user.

For example, a first object can be associated with an advertisement marketing a product, and the advertisement (and first object) can be displayed in a web site. A user can decide to purchase the product and can authenticate against a common identity service, so that the user can be identified and/or verified. The user can interact with the first object in association with the purchase of the product. Data regarding such interaction can be received by the CSC 102, and the evaluation component 106 can create a link 108 between the user and the first object.

The user can then see another advertisement for another product, where a second object can be associated therewith. The user, after being authenticated and identified, can interact with the second object in conjunction with the purchase of the other product. Data regarding the interaction of the user with the second object can be received by CSC 102 and evaluation component 106 can create a link 108 between the user and the second object. Further, the evaluation component 106 can create a link 108 between the first object and the second object, since the objects have the user in common. Moreover, a cluster 110 of users associated with the first object can be linked with the cluster 110 of users associated with the second object. Also, the contextual information associated with the first object can be linked with the contextual information associated with the second object.

In accordance with still another aspect of the disclosed subject matter, the CSC 102 can receive information from a contact list of a user, where the contact list can include information, such as identification information, regarding other users that the user has included on his/her contact list. The evaluation component 106 can analyze such received information and can create links 108 between the user and each of the other users who are on the user's contact list. Further, the evaluation component 106 create a cluster 110 that can include the user and each of the other users that are included on the user's contact list.

In accordance with one embodiment of the disclosed subject matter, the evaluation component 106 can facilitate weighting the ranking of comments, reviews, and/or ratings (e.g., publisher content) made by other users (e.g., publishers of publisher content) with regard to a product or service associated with an object based in part on user clusters 110 and/or contextual information respectively associated with the publishers. The evaluation component 106 can weight the publisher content of respective publishers to facilitate determining an order and/or prominence in displaying such publisher content based on various factors that can facilitate determining how closely linked the user (e.g., reader) encountering the advertisement and associated publisher content is respectively to each of the publishers. Such factors for weighting the publisher content of a respective publishers with regard to a product or service can be based on, for example, the number of contextual links 108 between the user (e.g., reader) who is encountering the advertisement, and associated object and publisher content, and a respective publisher; the number of contextual links 108 between the reader and the publisher that are related to the product or service marketed by the advertisement; and/or other contextual information (e.g., geographic location, gender, age, etc.) regarding the reader and a respective publisher.

For example, an advertisement marketing a product and associated object can be displayed on a web site. Users can provide comments, reviews, and/or ratings (e.g., publisher content) regarding the product. When a particular user encounters an object associated with the advertisement, evaluation component 106 can receive data regarding the particular user, the object, and/or the product, as well as data regarding other users, including users who are clustered with or otherwise linked with the particular user. The evaluation component 106 can weight publisher content respectively associated with the other users that have published content regarding the product based in part on the number and/or type of respective contextual links 108 between the particular user and the other users. Publisher content of a publisher who has one or more contextual links 108 with the particular user (e.g., the publisher and the particular user are grouped in a cluster(s)) can be ranked higher, and can be displayed ahead of and/or more prominently than publisher content of a user that has no contextual links with the particular user. Further, publisher content of a publisher who has more contextual links 108 with the particular user can be weighted higher than publisher content of a publisher who has less contextual links 108 to the particular user.

As another example, a particular user encounters an object associated with an advertisement for a certain product related to gaming. The particular user and a first publisher of content (e.g., product review) associated with the certain product have previously been contextually linked with regard to another object associated with another product related to gaming. The certain product and the other product are related to each other in that each product is related to gaming.

A second publisher has also provided a product review regarding the certain product. The particular user and the second publisher are also previously linked to each other, but such link 108 relates to a purchase of a book on history. The evaluation component 106 can receive and analyze such information and can weight published content of the first publisher higher than published content of the second publisher, since the first publisher and the particular user were previously contextually linked with regard to a product related to gaming, and the published content of the first publisher is made with regard to the certain product that is also a gaming product.

Turning back to interface 104, the system 100 can include any suitable and/or necessary interface component 104 (also herein referred to as “interface 104”), which can provide various adapters, connectors, channels, communication paths, etc. to integrate the CSC 102 into virtually any operating and/or database system(s) and/or with one another system(s). In addition, the interface component 104 can provide various adapters, connectors, channels, communication paths, etc., that can provide for interaction with the CSC 102, and/or any other component, data and the like associated with the system 100.

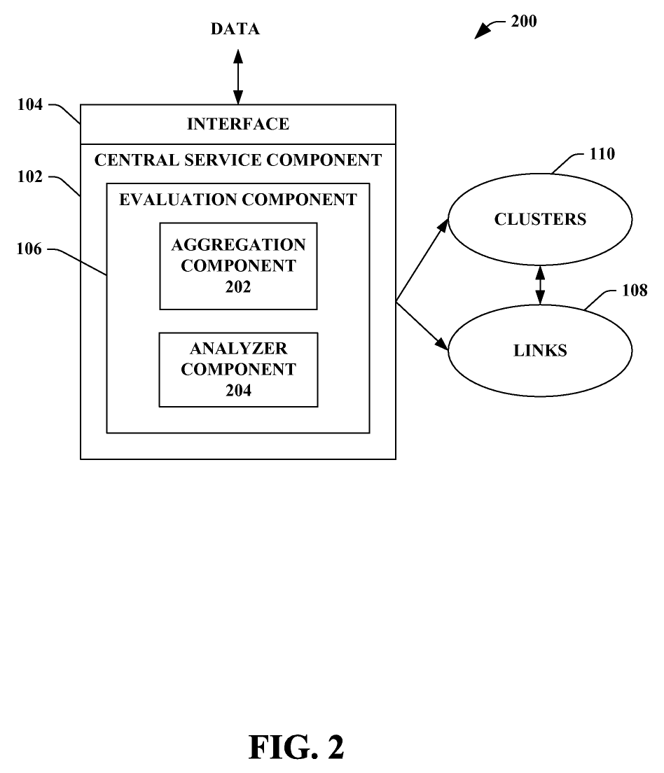

Referring to FIG. 2, illustrated is a system 200 that facilitates collecting data related to a user in order to facilitate linking and/or clustering users based on contextual object interactions of users. System 200 can include the CSC 102 that can receive data, via interface 104, associated with objects, online activity of users, users, host container(s) including or displaying object(s), advertisements, products, and/or services. The data can include information relating to users, clusters, links, products, and/or services, etc., as more fully described herein, for example, with regard to system 100.

CSC component 102 can include an evaluation component 106 that can facilitate determining links 108 between users, clustering of users, links 108 between clusters 110, and/or weighting of metadata (e.g., reviews, comments, and/or ratings of products or services) based in part on interactions of users with objects associated with and/or contained in advertisements marketing products and/or services, and/or associated with a central host service. The CSC 102 and the evaluation component 106 can each respectively function as more fully described herein, for example, with regard to system 100.

The evaluation component 106 can include an aggregation component 202 that can aggregate and/or organize the data received via the interface 104 in order to facilitate analyzing such data and facilitate creating links 108 between users with common interactions, creating clusters 110 of users who have had common interactions, creating links 108 between clusters 110 that have a particular user in common, and/or weighting information, such as metadata, etc. The aggregation component 202 can filter, select, and/or organize the data received by the CSC 102 and the evaluation component 106. For instance, the aggregation component 102 can identify portions of data that can be utilized for creating a link 108 between two users who have interacted with the same object. It is to be appreciated that the aggregation component 202 can be incorporated into the evaluation component 106 (as depicted), a stand-alone component, incorporated into a search component (not shown) that enables the browsing of data, and/or most any suitable combination thereof

The evaluation component 106 can include an analyzer component 204 that can analyze the received data in order to facilitate creating links 108 between users with common interactions, creating clusters 110 of users who have had common interactions, creating links 108 between clusters 110 that have a particular user in common, weighting information (e.g., metadata), etc. The analyzer component 204 can monitor/review data collected by the aggregation component 202 in order to create links 108 between users who have had common contextual interactions with an object(s), create clusters 110 of users based on common contextual interactions with an object(s), creating links 108 between clusters 110 that have a particular user in common, and/or creating a ranking of comments, reviews, and/or ratings made by users regarding products or services based in part on the contextual links 108 between users and/or clusters 110. It is to be appreciated that the analyzer component 204 can be incorporated into the evaluation component 106 (as depicted), a stand-alone component, incorporated into a search component (not shown), and/or most any suitable combination thereof.

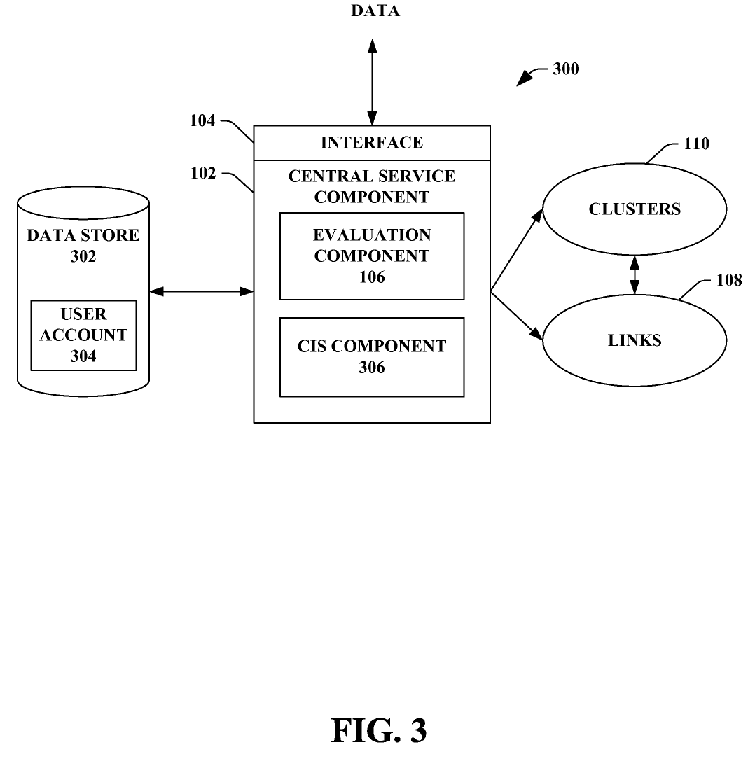

Turning to FIG. 3, depicted is a system 300 that facilitates creation of clusters of users based on contextual object interactions in accordance with the disclosed subject matter. System 300 can include CSC 102 that can receive data, via interface 104, associated with objects, online activity of users, users, advertisements, products, and/or services. The data can include information relating to users, clusters 110, links 108, the host container related to an object, advertisements, products, and/or services, etc., as more fully described herein, for example, with regard to system 100.

The system 300 can gather data associated with users, objects, advertisements, products and/or services marketed by advertisements, and/or other information (e.g., contextual information) across multiple sites (e.g., web sites, blogs, etc.) and/or across the network activity of a user(s) in order to provide a history of user activity, including object interactions and desired actions (e.g., purchases), for each particular user. Specifically, the system 300 can include the evaluation component 106 that can create links 108 between users, clusters 110 of users, links 108 between clusters 110, weighting of publisher content, and/or rankings of publisher content based at least in part upon received data (e.g., online activity, object interactions by users, etc.). The CSC 102 and the evaluation component 106 can each respectively function as more fully described herein, for example, with regard to system 100.

CSC 102 can be associated with a data store 302 that can store any suitable data (e.g., information) associated with objects, advertisements, products and/or services marketed by advertisements, online activity of users, users, etc., including, for example, data that can be received by CSC 102, as more fully described herein, for example, with regard to system 100. The data store 302 also can facilitate storing information associated with a user in a user account 304 associated with the user, and the user account 304 can be stored in data store 302.

CSC 102 can also include a common identity service (CIS) component 306 that can receive authentication information from one or more users to identify a particular user and verify (e.g., authenticate) a particular user, so that the identity of a particular user can be reasonably known by CSC 102. The CIS component 306 can request a user to authenticate, for example, when the user attempts to manipulate or interact with an object, attempts to purchase or perform another desired action with regard to an advertisement for a product or service, attempts to indicate interest in an advertisement or product or service associated therewith, such as by clicking on the advertisement, pledging an interest in product/service associated with the advertisement, etc.

The CIS component 306 can facilitate storing information in user account 304 that can be associated with a respective user, as the CIS component 306 can identify the respective user, so that the data store 302, CSC 102, and other components can know which user account 304 is to be accessed when sending data to or receiving data from data store 302, and/or associating data with the user account 304 when data is stored in data store 302.

It is to be appreciated that the data store 302 can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The data store 204 of the subject systems and methods is intended to comprise, without being limited to, these and any other suitable types of memory. In addition, it is to be appreciated that the data store 302 can be a server, a database, a hard drive, and the like.

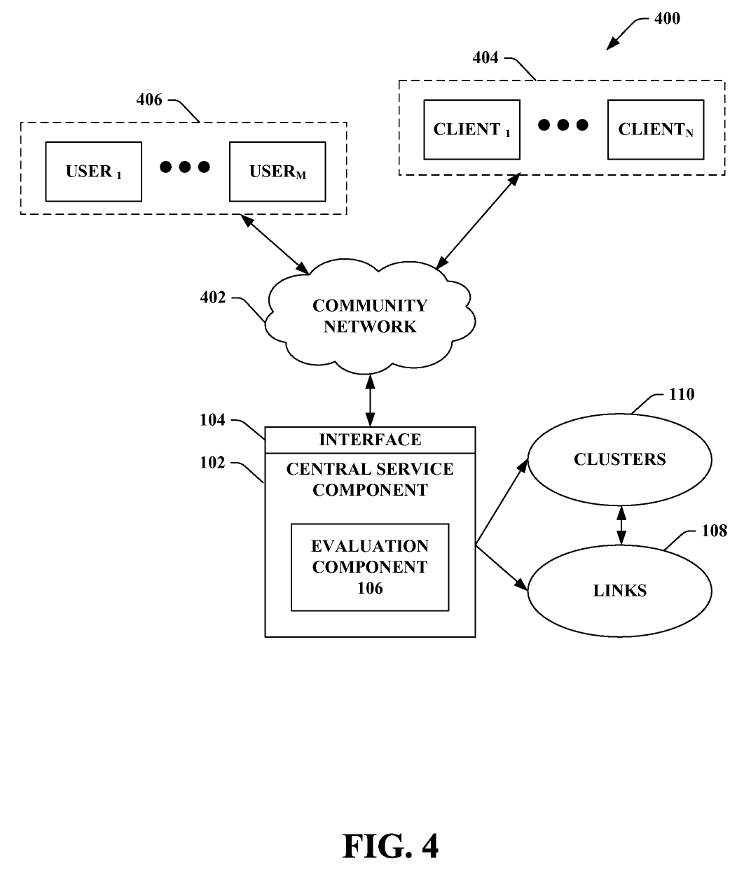

Turning to FIG. 4, depicted is a system 400 that can facilitate gleaning data associated with a community network in order to facilitate creating links and/or clusters between users in accordance with the disclosed subject matter. The system 400 can include CSC 102 that can receive data, via interface 104, associated with objects, users, online data of users, advertisements, products, and/or services, etc. The data can include information relating to objects, users, online activity of users, advertisements, products, and/or services, as more fully described herein, for example, with regard to system 100.

CSC component 102 can include an evaluation component 106 that can facilitate determining common interaction(s) of users with regard to an object(s), creating links 108 between users with common interaction(s) with object(s), creating clusters 110 of users, creating links 108 between clusters 110, based in part on information associated with interactions of users with objects associated with advertisements for products or services, and/or objects associated with central host services, for example. CSC 102 and the evaluation component 106 can function as more fully described herein, for example, with regard to system 100 and/or system 200.

For example, the evaluation component 106 can receive, from the community network 402, a portion of data associated with interactions of users with objects associated with advertisements for products and/or services. The evaluation component 106 can analyze the received data and can determine if there are common interactions with the same object by respective users, and/or common interactions of respective users with different objects that are linked. The evaluation component 106 can create links 108 between users that have interacted with the same object and/or with different objects that have been linked, and can create cluster(s) 110 that can include users with interactions with objects in common.

Furthermore, the CSC 102 can interact with a community network 402. Further, the community network 402 can include most any suitable number of clients 404, such as client I to client N, where N is a positive integer, that can be associated with the community network 402. The client(s) can be merchant(s), advertiser(s), retailer(s), wholesaler(s), etc. that can facilitate generation of online advertisements, and/or objects respectively associated therewith, related to products, services, and/or other commerce.

The community network 402 also can include most any suitable number of users 406, such as user 1 to user M, where M is a positive integer. A user 406 can be a party that can interact with an object(s), perform desired action(s) with regard to advertisements and products or services marketed associated therewith, and/or publish content (e.g., metadata, such as reviews, comments, or ratings associated with a product or service), for example. It is to be appreciated that the CSC 102 can differentiate between respective users 406 as well as between respective clients 404 in the community network 402.

In one example, the community network 402 can be a network associated with commerce and/or transactions related to commerce such as buying an item, a product, and/or service; selling an item, a product, and/or service; buying a portion of an item, a product, and/or a service; selling a portion of an item, a product, and/or a service, etc. The CSC 102 and evaluation component 106 can receive and analyze data from the community network 402 in order to facilitate determining common interactions of user with regard to objects that can be respectively associated with advertisements for products or services. In particular, the CSC 102 can link and/or cluster respective users 406 associated with the network 402 based in part on the evaluation of data, such as data associated with objects and interactions with such objects by users, obtained from the community network 402. It is to be appreciated that community network 402 can be comprised of one or more disparate networks that can cooperate with each other.

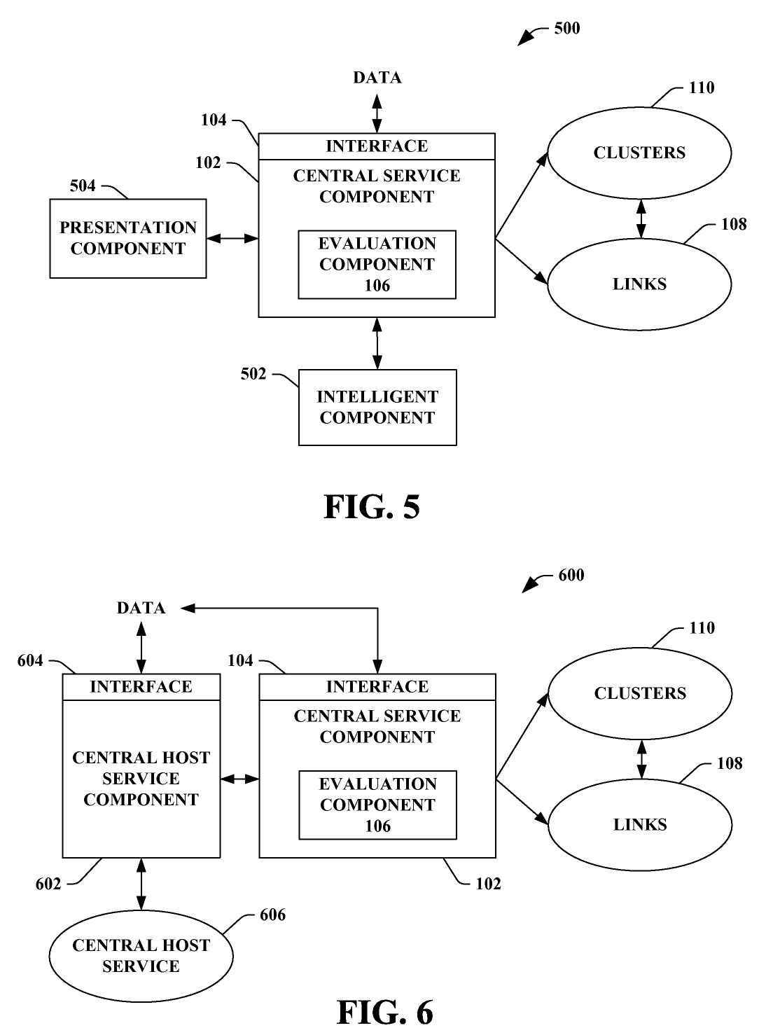

FIG. 5 illustrates a system 500 that can employ intelligence to facilitate determining common interactions of users with regard to objects in accordance with the disclosed subject matter. The system 500 can include the CSC 102 and the interface 104, wherein it is to be appreciated that the CSC 102, the interface 104, the evaluation component 106, and other components, can be substantially similar to respective components and interfaces described with regard to system 100, system 200, 300, and/or system 400. The system 500 can further include an intelligent component 502. The intelligent component 502 can be utilized by the CSC 102 to facilitate analyzing data to determine whether there exist common interactions of users with regard to the same object and/or linked objects, whether respective users can be linked to each other, whether respective users can be clustered together in a group, whether respective clusters can be linked together, etc.

For example, the intelligent component 502 can infer whether a user has interacted with an object, whether information on a host container is contextually related to the object and whether such information should be included in a set of contextual information that can be associated with the object, whether respective users can be linked due to respective object interactions of each user, whether respective users can be included in a cluster 110 due to respective object interactions of each user, whether respective clusters can be linked together, a weighting level and/or a ranking of a comment, review, and/or rating made by a user with regard to a product or service associated with an object, etc.

It is to be understood that the intelligent component 502 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data (e.g., historical data), whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the disclosed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

The CSC 102 can further utilize a presentation component 504 that provides various types of user interfaces to facilitate interaction between a user and any component coupled to the CSC 102. As depicted, the presentation component 504 is a separate entity that can be utilized with the CSC 102. However, it is to be appreciated that the presentation component 504 and/or similar view components can be incorporated into the CSC 102 and/or a stand-alone unit. The presentation component 504 can provide one or more graphical user interfaces (GUIs), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled and/or incorporated into the CSC 102.

The user can also interact with the regions to select and provide information via various devices such as a mouse, a roller ball, a keypad, a keyboard, a pen and/or voice activation, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can than provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

FIG. 6 illustrates a system 600 that can employ centrally hosted service(s) to facilitate contextual clusterization of users in accordance with the disclosed subject matter. The system 600 can include the CSC 102, interface 104, and evaluation component 106, wherein it is to be appreciated that such components and interfaces, and other components and interfaces, can be substantially similar to respective components and interfaces described with regard to system 100, system 200, 300, system 400, and/or system 500.

System 600 can gather data associated with users, user activity, the host container that hosts an object, advertisements, products, services, primary actions, community actions, syndication actions, object metadata, and/or other data. The evaluation component 106 can analyze the received information and can facilitate determining common interaction(s) of users with regard to an object(s), creating links 108 between users with common interaction(s) with object(s), creating clusters 110 of users, and/or creating links 108 between clusters 110, based in part on information associated with interactions of users with objects associated with advertisements for products or services, and/or objects associated with central host services, for example.

The system 600 can further include a central host service component 602. The central host service component 602 can be utilized to perform a portion of the functions associated with the CSC 102, as such functions have been more fully described herein. For example, central host service component 602 can receive data via interface component 604 from an object contained in a site (e.g., web site, blog, e-mail, etc.) and can analyze such data to facilitate linking and/or clustering users that have common interactions, linking clusters based on common user(s), identifying and/or authenticating users, as well as other functions that can be delegated to the central host service component 602. The central host service component 602 can be associated with CSC 102 and data can be transferred between central host service component 602 and CSC 102 via their respective interfaces 604 and 108, for example.

Central host service component 602 can also provide central host services 606, for example, to a host container of a user-publisher. The central host service component 602 can facilitate providing an object that can have a service 606 (e.g., central host service) associated therewith. The central host services 606 can include, for example, weather information, instant message or online status information regarding users, stock quotes, horoscope information, news feed, sports feed, a counter related to users who access the host site, and/or graphics.

A central host service 606 can be provided by an entity (e.g., advertiser, merchant) via the central host service component 602, for example, and the object and associated service 606 can be included in the host container (e.g., web site, blog, e-mail) of a user-publisher. In exchange for a user-publisher hosting an object and associated service 606 on the site of the user-publisher, the entity can provide an incentive to the user-publisher, and/or the user-publisher can benefit simply from the additional functionality or service provided by his/her site, which can generate increased traffic. Further, the CSC 102, and thereby the entity, can obtain information regarding users who access the site of the publisher-user.

In accordance with one embodiment of the disclosed subject matter, the central host service component 602 can receive a request from a user, via interface 604, to access a site having an object and associated central host service 606 contained therein. The central host service component 602 can identify the user and/or can receive identification information regarding the user and/or contextual information, such as information contained in the host container. The central host service component 602 can facilitate connecting the user to the requested page. Further, the central host service component 602 can facilitate providing the central host service 606 (e.g., weather, stock quotes, etc.) associated with the object. The central host service component 602 can also facilitate providing the received information to the CSC 102. Thus, simply by a user(s) accessing a site (or requesting to access a site) of a user-publisher, the CSC 102 can obtain information regarding the user(s).

The aforementioned systems have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

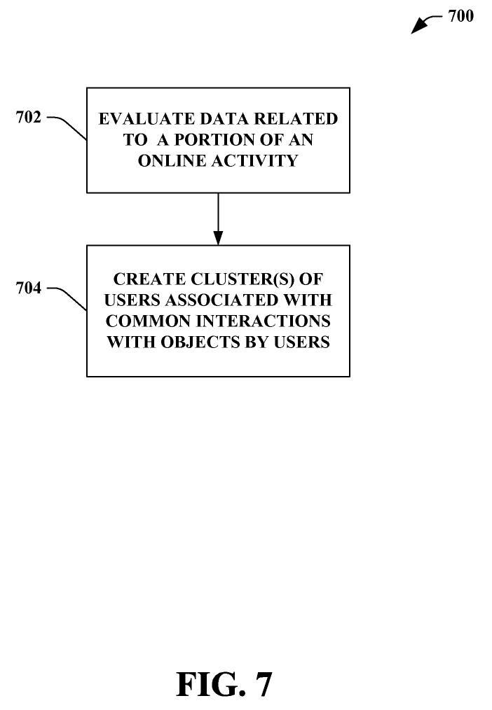

FIGS. 7-10 illustrate methodologies and/or flow diagrams in accordance with the disclosed subject matter. For simplicity of explanation, the methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Turning now to FIG. 7, depicted is a methodology 700 that can facilitate creating cluster(s) of users based on common contextual object interactions of users in accordance with the disclosed subject matter. At 702, data, or a portion thereof, related to objects, advertisements, products or services respectively associated with the advertisements, users, online user activity, and other data can be analyzed and/or evaluated, for example, by the CSC 102 and/or the evaluation component 106 that can be included therein. For example, data relating to objects can include data associated with objects, the type of advertisement associated with an object, the product and/or service marketed by the advertisement, where the advertisement and/or object originated, the host container of an object, the time an object is posted, embedded, and/or displayed; the time a desired action (e.g., purchase or other activity desired by the advertiser) is performed by a user; metadata (e.g., comments, reviews, and/or ratings regarding a product or service), user(s) that have interacted with the object, etc. The CSC 102 can receive such data via interface 104 and/or can retrieve such data from the data store 302 and can evaluate such data. Information regarding objects and object interactions can also be as described herein, for example, with regard to system 100, and can include information (e.g., advertisement) associated with a product(s) and/or service(s), as more fully described herein, for example, with regard to system 100. Further, objects can be included in virtually any form of online electronic communication (e.g., e-mail, web site, etc.), as more fully described herein, for example, with regard to system 100.

An object(s) can also be associated with a central host service (e.g. weather information service, stock quote service, etc.) that can be provided to a publisher and included on the site or other online electronic communication associated with a publisher, and can be utilized to obtain information regarding users disposed in a community network and/or associated networks. Further, objects can be included in virtually any form of online electronic communication (e.g., e-mail, web site, etc.), as more fully described herein, for example, with regard to system 100.

At 704, one or more clusters 110 can be created based in part on the evaluation of the received data, wherein a cluster 110 can be associated with common interaction(s) of users with an object(s). The evaluation component 106 can determine whether there exists one or more common interactions with an object(s) by respective users based in part on the evaluation of the received data. The evaluation component 106 can analyze the received data and can determine whether one or more users manipulated the object thereby interacting with such object. The object can be included with an advertisement marketing a product or service, for example. Such object and advertisement can be displayed or included in a web site, blog, e-mail, instant message, SMS, EMS, and/or other form of electronic communication. If the evaluation component 106 determines that more than one user interacted with a particular object, the evaluation component 106 can determine that such users have had a common interaction with regard to such object. The evaluation component 106 can then create a link 108 between each user that has interacted with the object. Further, evaluation component 106 can create one or more clusters 110, where a cluster 110 can include each user that has interacted with the object that can be associated with the cluster 110 along with contextual information associated with the object. At this point, methodology 700 can end.

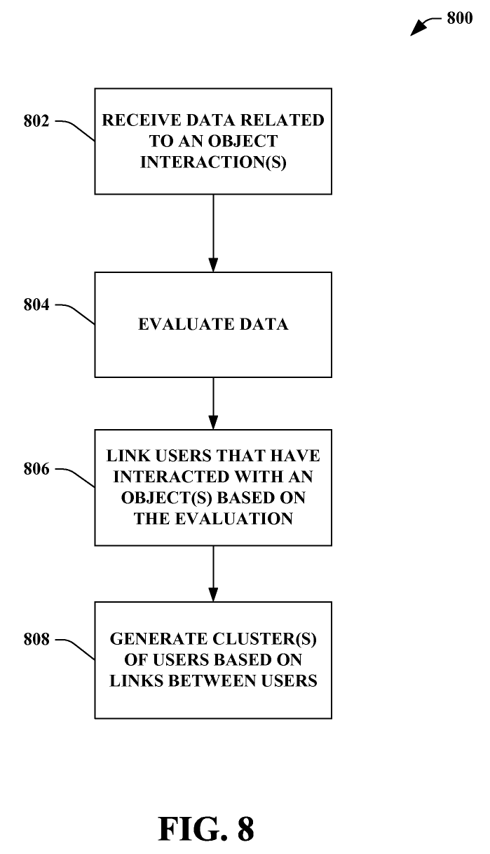

Referring to FIG. 8, a methodology 800 that can facilitate creating clusters of users based on contextual object interaction is illustrated. At 802, data, or a portion thereof, related to an object interaction(s), or a portion thereof, can be received, for example, by CSC 102. The object interaction(s) can be associated with an object(s) (e.g. control(s)), where an object can be associated with an advertisement that can promote a product or service, and/or an object can be associated with a central host service (e.g., weather information service, stock quotes service). A user(s) can manipulate (e.g., interact with) an object, for example, to purchase, or perform another desired action with regard to, the product or service associated therewith. Interaction with an object can include requesting to access or view a page (e.g., web site, blog, e-mail, etc.) that has an object contained therein, and/or clicking on an object, for example.

The data relating to object interactions can include, for example, data associated with the object(s), the type of advertisement associated with an object, the product and/or service marketed by the advertisement, where the advertisement and/or object originated, the host container of an object, the time an object is posted, embedded, and/or displayed; the time an object is manipulated (e.g., interacted with) by a user; the time a desired action (e.g., purchase or other activity desired by the advertiser) is performed by a user; metadata (e.g., comments, reviews, and/or ratings regarding a product or service), contextual information associated with the object, user(s) that have interacted with the object, etc.

The CSC 102 can receive such data via interface 104 and/or can retrieve such data from the data store 302 and can evaluate such data. Information regarding objects and object interactions can also be as described herein, for example, with regard to system 100, and can include information (e.g., advertisement) associated with a product(s) and/or service(s), as more fully described herein, for example, with regard to system 100. Further, objects can be included in virtually any form of online electronic communication (e.g., e-mail, web site, etc.), as more fully described herein, for example, with regard to system 100.

At 804, the received data, or a portion thereof, related to objects interactions can be analyzed and/or evaluated, for example, by the CSC 102 and/or the evaluation component 106 that can be included therein. The data can be analyzed and evaluated to determine, for example, whether more than one user has interacted with a particular object.

At 806, if the evaluation of the received data demonstrates that more than one user has interacted with an object, each user that has interacted with the object can be linked together. For example, the evaluation component can create a link 108 between each user that has interacted with a particular object.

At 808, one or more clusters 110 can be generated based on the evaluation of the data and the links 108 between respective users. Where more than one user is linked to an object, a cluster 110 can be created that can include each user that has interacted with the object. For example, evaluation component 106 can generate a cluster 110 that can include each user that has interacted with an object. Further, the evaluation component 106 can facilitate associating contextual information (e.g., information regarding content included in the host container associated with the object, advertisement information, etc.) related to the object with the cluster 110 and the users included therein. At this point, methodology 800 can end.

It is to be appreciated that, while methodology 800 is described in part with regard to one object, more than one object can be evaluated, and evaluation component 106 can receive data, and can evaluate data, relating to any number of objects. Further, it is to appreciated that, while methodology 800 describes users being linked together based on their interaction with an object, in accordance with the disclosed subject matter, users can also be linked to each other when a user interacts with an object, and that object is linked to another object, and another user has interacted with the other object.

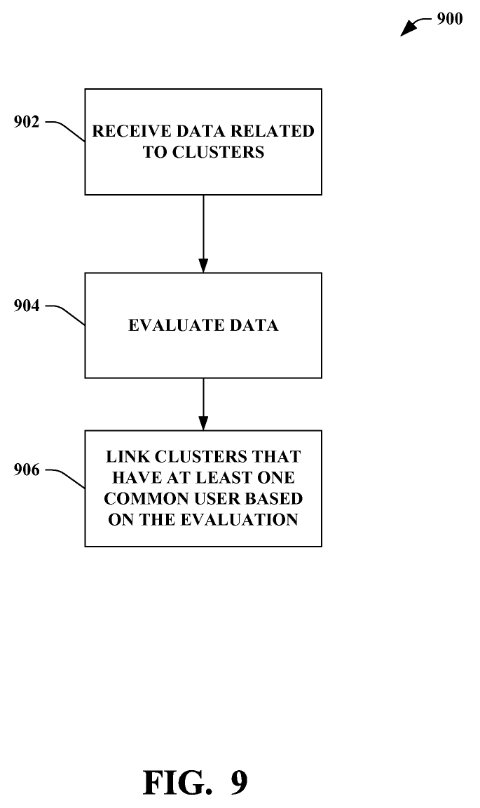

Turning to FIG. 9, a methodology 900 that can facilitate linking clusters 110 based on a common user(s) is illustrated. At 902, data, or a portion thereof, related to clusters 110 of users, or a portion thereof, can be received, for example, by CSC 102. Each cluster 110 can be associated with an object(s), where an object can be associated with an advertisement that can promote a product or service, and/or can be associated with a central host service (e.g., weather information service, stock quotes service). Further, each cluster 110 can be associated with the users included within the cluster 110. A user can be grouped in a cluster 110 with other users, where each user has interacted (e.g., viewed, requested to view, mouse clicked) with the object associated with the cluster 110, for example. The data relating to clusters 110 can include, for example, data associated with the object(s) associated with a cluster 110, the type of advertisement associated with an object, the product and/or service marketed by the advertisement, where the advertisement and/or object originated, the host container of an object (e.g., content included within or displayed on host container), the time an object is posted, embedded, and/or displayed; the time an object is manipulated (e.g., interacted with) by a user; the users within a cluster 110; the time a desired action (e.g., purchase or other activity desired by the advertiser) is performed by a user; metadata (e.g., comments, reviews, and/or ratings regarding a product or service) associated with an object, contextual information associated with the object, etc.

The CSC 102 can receive such data via interface 104 and/or can retrieve such data from the data store 302 and can evaluate such data. Information regarding clusters 110 can also be as described herein, for example, with regard to system 100, and can include information (e.g., advertisement) associated with a product(s) and/or service(s), as more fully described herein, for example, with regard to system 100. Further, objects can be included in virtually any form of online electronic communication (e.g., e-mail, web site, etc.), as more fully described herein, for example, with regard to system 100.

At 904, the received data, or a portion thereof, related to clusters 110 can be analyzed and/or evaluated, for example, by the CSC 102 and/or the evaluation component 106 that can be included therein. The data can be analyzed and evaluated to determine, for example, whether more than one cluster 110 have a particular user in common.

At 906, if the evaluation of the received data demonstrates that more than one cluster 110 have a particular user(s) in common, each cluster 110 that includes the particular user(s) can be linked together. For example, the evaluation component can create a link 108 between each cluster 110 that includes therein a particular user(s). Further, the evaluation component 106 can facilitate associating or linking the contextual information respectfully associated with each cluster 110 to each other cluster 110 linked thereto. At this point, methodology 900 can end.

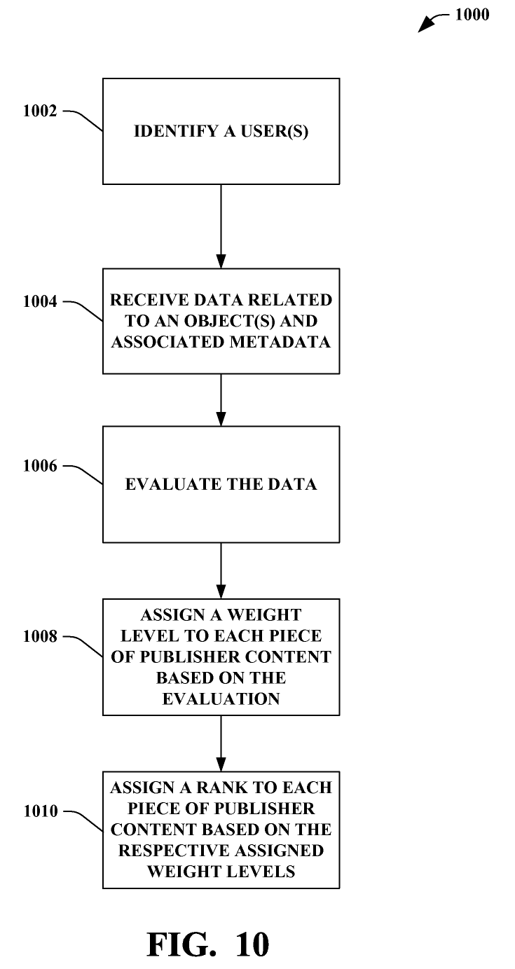

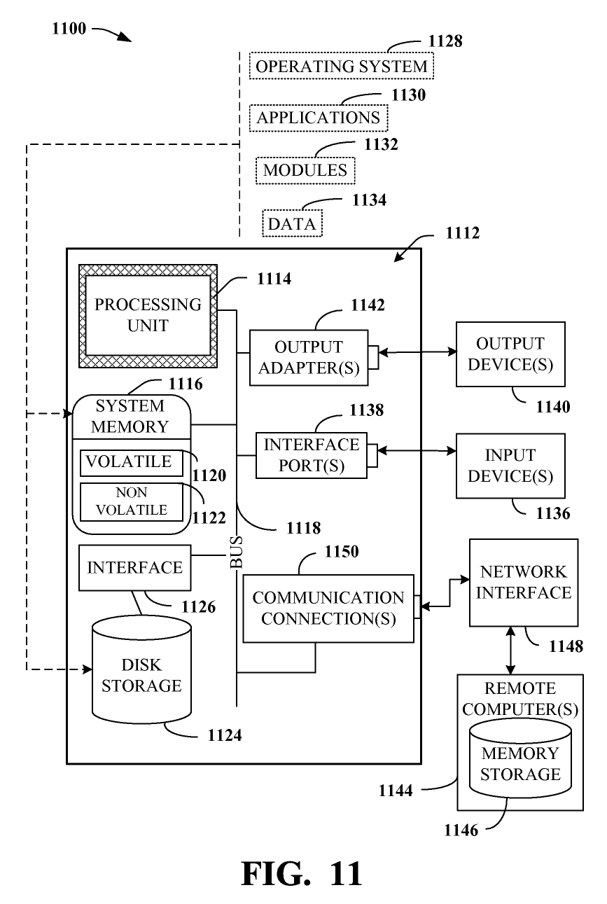

Referring to FIG. 10, illustrated is a methodology 1000 that can facilitate weighting or ranking content associated with an object and published by a user in accordance with the disclosed subject matter. At 1002, a user can be identified. For example, a user can be associated with a community network 402 and can be identified by a common identity service (e.g., CIS component 306) based on authentication information associated with the user that the user can provide to identify the user and verify who the user is for the common identity service as well as other components (e.g., CSC 102) associated therewith.

At 1004, data, or a portion thereof, related to objects and associated metadata (e.g., published content, such as user comments, reviews, ratings, associated with the object and products/services related thereto) can be received, for example, by CSC 102. An object can be associated with an advertisement marketing a product(s) or service(s). Users can provide comments, reviews, ratings, and/or other content related to the product(s) or service(s), which can be metadata that can be associated with the object. Such content can be displayed in the advertisement and/or the host container (e.g., web site, blog, etc.) associated with the object. The data relating to objects, and associated metadata, can include, for example, data associated with an object(s), the type of advertisement associated with an object, the product and/or service marketed by the advertisement, where the advertisement and/or object originated, the host container of an object, the time an object is posted, embedded, and/or displayed; the time an object is manipulated (e.g., interacted with) by a user; cluster(s) 110 associated with an object; the time a desired action (e.g., purchase or other activity desired by the advertiser) is performed by a user; metadata (e.g., comments, reviews, and/or ratings regarding a product or service) associated with an object, contextual information associated with an object, etc.

The CSC 102 can receive such data via interface 104 and/or can retrieve such data from the data store 302 and can evaluate such data. Information (e.g., data) regarding objects, and associated metadata, can also be as described herein, for example, with regard to system 100, and can include information (e.g., advertisement) associated with a product(s) and/or service(s), as more fully described herein, for example, with regard to system 100. Further, objects can be included in virtually any form of online electronic communication (e.g., e-mail, web site, etc.), as more fully described herein, for example, with regard to system 100.

At 1006, the received data, or a portion thereof, related to objects and respectively associated metadata can be analyzed and/or evaluated, for example, by the CSC 102 and/or the evaluation component 106 that can be included therein. The received data can be analyzed and evaluated to determine, for example, whether a user who is viewing, or taking a desired action with regard to, an advertisement for a product or service that can be associated with an object, and/or manipulating and/or interacting with the object is linked and/or included in a cluster 110 with another user(s) (e.g., publisher) who has published content (e.g., publisher content) associated with the object/advertisement that can be displayed therein or within the host container; if a link(s) and/or cluster(s) 110 exists between the user and a publisher(s), the context or nature of such link(s) or cluster(s) 110; the number of links or clusters 110 associated with each of the user and the publisher; the time that such links or clusters 110 were created, etc.

At 1008, a weight level can be assigned to each piece of publisher content of a publisher that is associated with an object. The weight level assigned to a particular piece of publisher content can be based on various factors, such as the number of links between the user and the publisher; the number of clusters 110 in which both the user and a particular publisher are grouped together; the context or nature of each of the links or clusters 110 between a user and a particular publisher; the time(s) that the user and the publisher were linked and/or clustered together; etc.

For example, a first publisher, second publisher, and third publisher can each publish respective content (e.g., comments) regarding a gaming product marketed by an advertisement in the web site wherein the advertisement is displayed. An identified user accesses the web site. The first publisher has is grouped with the user in three clusters, where none of the clusters is related to gaming. The second publisher is grouped with the user in one cluster that is related to gaming. The third publisher has no links or clusters in common with the user.

The evaluation component 106 can receive this data, and other data, and can determine that the user accessing the web site and viewing the advertisement therein, and associated object, is included in three clusters 110 with the first publisher is included in one cluster 110 with the second publisher, and has no links or clusters in common with the third publisher. Further, the evaluation component 106 can facilitate assigning a predetermined weight level to each piece of published content respectively associated with each publisher based on the number of clusters 110 or links that exist between the user and a particular publisher. The evaluation component 106 can assign a higher weight level to the published content of the first publisher because the first publisher and the user are in more clusters together than the user is with regard to the other publishers. The published content of the second publisher can be assigned a weight level that is more than the published content of the third publisher, but less than that of the published content of the first publisher, because the second publisher has more clusters in common with the user than the third publisher, but less than the first publisher.

To further illustrate, when evaluating the context of the previous clustering or links between the user and the publishers, the evaluation component 106 can assign a higher weight level to the publisher content of the second publisher, as compared to the content of the first publisher and the content of the third publisher, because of the previous contextual relationship between the user and the second publisher. In particular, the user and the second publisher are included in a cluster 110 associated with gaming, and the product in the current advertisement being viewed by the user is a gaming product. Thus, given such a contextual relationship, the publisher content of the second publisher may have more relevance to the user than the publisher content of the other publishers. After the evaluation component 106 has evaluated the data in light of the weighting factors, the various weight levels assigned to each piece of publisher content based on each factor can be evaluated to determine a final weight level to be assigned to a particular piece of publisher content.

At 1010, a ranking of the pieces of publisher content can be determined. The ranking can be based in part on the respective weight levels of each piece of publisher content, as determined at 1008, for example. Further, the ranking can be based on other factors, such as, for example, the number of pieces of publisher content a user has published; a ranking of a publisher, which can be based on ratings, comments, etc. provided by other users; etc. At this point, methodology 1000 can end.

It should be appreciated that the methodologies disclosed herein and throughout this specification are capable of being stored on an article of manufacture to facilitate transporting and transferring such methodologies to computers. The term article of manufacture, as used herein, is intended to encompass a computer program accessible from any computer-readable device, carrier, or media.

It should also be appreciated that some portions of the detailed description have been presented in terms of algorithms and/or symbolic representations of operations on data bits within a computer memory. These algorithmic descriptions and/or representations are the means employed by those cognizant in the art to most effectively convey the substance of their work to others equally skilled. An algorithm is here, generally, conceived to be a self-consistent sequence of acts leading to a desired result. The acts are those requiring physical manipulations of physical quantities. Typically, though not necessarily, these quantities take the form of electrical and/or magnetic signals capable of being stored, transferred, combined, compared, and/or otherwise manipulated.

Further, it has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the foregoing discussion, it is appreciated that throughout the disclosed subject matter, discussions utilizing terms such as processing, computing, calculating, determining, and/or displaying, and the like, refer to the action and processes of computer systems, and/or similar consumer and/or industrial electronic devices and/or machines, that manipulate and/or transform data represented as physical (electrical and/or electronic) quantities within the computer's and/or machine's registers and memories into other data similarly represented as physical quantities within the machine and/or computer system memories or registers or other such information storage, transmission and/or display devices.

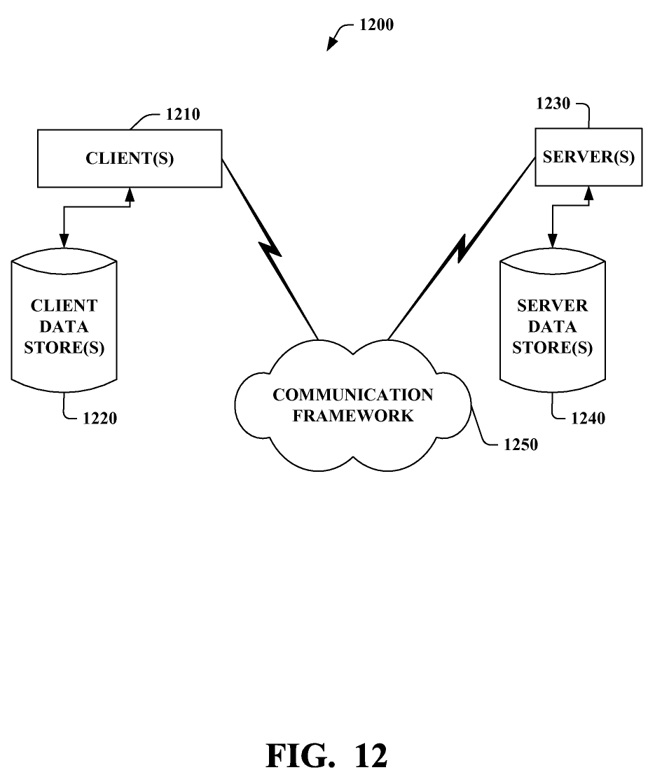

In order to provide a context for the various aspects of the disclosed subject matter, FIGS. 11 and 12 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., personal digital assistant (PDA), phone, watch), microprocessor-based or programmable consumer or industrial electronics, and the like. The illustrated aspects may also be practiced in distributed computing environments where tasks are performed by remote processing devices that are linked through a communications network. However, some, if not all aspects of the claimed innovation can be practiced on stand-alone computers. In a distributed computing environment, program modules may be located in both local and remote memory storage devices.

With reference to FIG. 11, a suitable environment 1100 for implementing various aspects of the claimed subject matter includes a computer 1112. The computer 1112 includes a processing unit 1114, a system memory 1116, and a system bus 1118. The system bus 1118 couples system components including, but not limited to, the system memory 1116 to the processing unit 1114. The processing unit 1114 can be any of various available processors. Dual microprocessors and other multiprocessor architectures also can be employed as the processing unit 1114.

The system bus 1118 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1116 includes volatile memory 1120 and nonvolatile memory 1122. The basic input/output system (BIOS), containing the basic routines to transfer information between elements within the computer 1112, such as during start-up, is stored in nonvolatile memory 1122. By way of illustration, and not limitation, nonvolatile memory 1122 can include read only memory (ROM), programmable ROM (PROM), electrically programmable ROM (EPROM), electrically erasable programmable ROM (EEPROM), or flash memory. Volatile memory 1120 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1112 also includes removable/non-removable, volatile/non-volatile computer storage media. FIG. 11 illustrates, for example, a disk storage 1124. Disk storage 1124 includes, but is not limited to, devices like a magnetic disk drive, floppy disk drive, tape drive, Jaz drive, Zip drive, LS-100 drive, flash memory card, or memory stick. In addition, disk storage 1124 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1124 to the system bus 1118, a removable or non-removable interface is typically used, such as interface 1126.

It is to be appreciated that FIG. 11 describes software that acts as an intermediary between users and the basic computer resources described in the suitable operating environment 1100. Such software includes an operating system 1128. Operating system 1128, which can be stored on disk storage 1124, acts to control and allocate resources of the computer system 1112. System applications 1130 take advantage of the management of resources by operating system 1128 through program modules 1132 and program data 1134 stored either in system memory 1116 or on disk storage 1124. It is to be appreciated that the claimed subject matter can be implemented with various operating systems or combinations of operating systems.

A user enters commands or information into the computer 1112 through input device(s) 1136. Input devices 1136 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1114 through the system bus 1118 via interface port(s) 1138. Interface port(s) 1138 include, for example, a serial port, a parallel port, a game port, and a universal serial bus (USB). Output device(s) 1140 use some of the same type of ports as input device(s) 1136. Thus, for example, a USB port may be used to provide input to computer 1112, and to output information from computer 1112 to an output device 1140. Output adapter 1142 is provided to illustrate that there are some output devices 1140 like monitors, speakers, and printers, among other output devices 1140, which require special adapters. The output adapters 1142 include, by way of illustration and not limitation, video and sound cards that provide a means of connection between the output device 1140 and the system bus 1118. It should be noted that other devices and/or systems of devices provide both input and output capabilities such as remote computer(s) 1144.

Computer 1112 can operate in a networked environment using logical connections to one or more remote computers, such as remote computer(s) 1144. The remote computer(s) 1144 can be a personal computer, a server, a router, a network PC, a workstation, a microprocessor based appliance, a peer device or other common network node and the like, and typically includes many or all of the elements described relative to computer 1112. For purposes of brevity, only a memory storage device 1146 is illustrated with remote computer(s) 1144. Remote computer(s) 1144 is logically connected to computer 1112 through a network interface 1148 and then physically connected via communication connection 1150. Network interface 1148 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1150 refers to the hardware/software employed to connect the network interface 1148 to the bus 1118. While communication connection 1150 is shown for illustrative clarity inside computer 1112, it can also be external to computer 1112. The hardware/software necessary for connection to the network interface 1148 includes, for exemplary purposes only, internal and external technologies such as, modems including regular telephone grade modems, cable modems and DSL modems, ISDN adapters, and Ethernet cards.

FIG. 12 is a schematic block diagram of a sample-computing environment 1200 with which the subject innovation can interact. The system 1200 includes one or more client(s) 1210. The client(s) 1210 can be hardware and/or software (e.g., threads, processes, computing devices). The system 1200 also includes one or more server(s) 1230. Thus, system 1200 can correspond to a two-tier client server model or a multi-tier model (e.g., client, middle tier server, data server), amongst other models. The server(s) 1230 can also be hardware and/or software (e.g., threads, processes, computing devices). The servers 1230 can house threads to perform transformations by employing the subject innovation, for example. One possible communication between a client 1210 and a server 1230 may be in the form of a data packet transmitted between two or more computer processes.

The system 1200 includes a communication framework 1250 that can be employed to facilitate communications between the client(s) 1210 and the server(s) 1230. The client(s) 1210 are operatively connected to one or more client data store(s) 1220 that can be employed to store information local to the client(s) 1210. Similarly, the server(s) 1230 are operatively connected to one or more server data store(s) 1240 that can be employed to store information local to the servers 1230.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has,” or “having,” or variations thereof, are used in either the detailed description or the claims, such terms are intended to be inclusive in a manner similar to the term “comprising” as “comprising” is interpreted when employed as a transitional word in a claim.

What is claimed is:

1. A system that facilitates clusterization of users, comprising:
a central service component that receives information associated with at least one object related to at least one of a product, a service, or a central host service, or a combination thereof, creates at least one cluster that includes a user and at least one other user if the user and the at least one other user each have interacted with the at least one object.

2. The system of claim 1, further comprising an evaluation component that is associated with the central service component and receives information associated with the at least one object, analyzes the received information, and compares the received information to a subset of cluster criteria.

3. The system of claim 2, the evaluation component creates a link between the user and contextual information associated with the at least one object with which the user interacted.

4. The system of claim 2, the evaluation component creates a link between the at least one object and at least one other object if the user interacts with the at least one object and the at least one other object.

5. The system of claim 2, the evaluation component links a cluster and at least one other cluster together, if the cluster and the at least one other cluster have at least one user who is included in each of the cluster and the at least one other cluster.

6. The system of claim 2, the evaluation component assigns a weight level to a piece of content associated with at least one publisher based on at least one of a number and a type of contextual links between the user and the at least one publisher, the at least one publisher is one user of a plurality of users.

7. The system of claim 1, interaction with the at least one object comprises at least one of a request to view a site associated with the at least one object, a view of a site associated with the at least one object, a click of a mouse on the at least one object, a keystroke to press a button associated with the at least one object, a voice command to take an action with regard to the at least one object, or a manipulation of the at least one object, or a combination thereof.

8. The system of claim 1, further comprising a data store that can store data associated with at least one of a user, the at least one object, a cluster, a link, or a combination thereof.

9. The system of claim 1, further comprising a common identity service component that identifies and verifies the identification of a user.

10. The system of claim 1, further comprising a central host service component that provides at least one central host service, the at least one central host service comprising at least one of a weather service, an online status information service, a stock quote service, a horoscope service, a news feed service, a sports feed service, a counter, or a provision of graphics, or a combination thereof.

11. The system of claim 1, further comprising an intelligent component that makes an inference as to the at least one of whether an interaction with an object has occurred, a number of links between a user and at least one other user, a type of contextual link between a user and at least one other user, a contextual relationship between a user and at least one cluster, a contextual relationship between an object and data, a contextual link between a cluster and at least one other cluster, a weight level associated with content, a ranking associated with content, or a combination thereof.

12. The system of claim 1, the at least one object is contained in at least one of a web site, a web page, a webfeed, a blog, an e-mail, an instant message, a short message service, a multimedia messaging service, an enhanced messaging service, or a combination thereof.

13. At least one computer that comprises the central service component of claim 1.

14. A method that facilitates clustering users, comprising:
evaluating a subset of information associated with at least one object associated with at least one of a product, a service, or a central host service, or a combination thereof; and
creating a cluster that includes a user and at least one other user when the user and the at least one other user have each interacted with the at least one object.

15. The method of claim 14, further comprising:
creating a link between a cluster and at least one other cluster when at least one user is associated with the cluster and the at least one other cluster; and
linking contextual information associated with the cluster with the at least one other cluster.

16. The method of claim 14, further comprising:
creating a link between the at least one object and at least one other object when the at least one user interacts with each of the at least one object and the at least one other object; and
linking contextual information associated with the at least one object with the at least one other object.

17. The method of claim 14, further comprising:
receiving information associated with at least one of an object, an advertisement, a product, a service, a time an object was created, a time an object was subject to interaction, a time a desired action is performed, metadata associated with an object, user activity, or the at least one user, or a combination thereof.

18. The method of claim 14, further comprising:
assigning a weight to content associated with the at least one object based on object interaction information respectively associated with the at least one user and the at least one other user; and
assigning a rank to the content based in part on the weight assigned to the content.

19. A system for clustering users, comprising:
means for analyzing data associated with at least one object associated with at least one of a product, a service, or a central host service, or a combination thereof; and
means for creating a cluster that includes a user and at least one other user who each have interacted with the at least one object.

20. The system of claim 19, further comprising:
means for monitoring data associated with at least one of the user, the at least one other user, the at least one object, an advertisement, a product, a service, or a host container, or a combination thereof;
means for receiving the data;
means for storing the data;
means for linking the at least one object and at least one other object based on object interaction data associated with the user;
means for linking a cluster and at least one other cluster based on object interaction data associated with the user;
means for assigning a weight to at least one of a comment, a review, or a rating, or a combination thereof, made by a publisher with regard to at least one of a product or service, or a combination thereof, associated with the at least one object, based in part on respective object interaction data of the user and the publisher, the publisher is one user of a plurality of users; and
means for assigning a rank to at least one of a comment, a review, or a rating, or a combination thereof, made by the publisher with regard to at least one of a product or service, or a combination thereof, associated with the at least one object, based in part on respective object interaction data of the user and the publisher.
